(19) United States
(12) Patent Application Publication
(10) Pub. No.: US 2025/0354887 A1
(43) Pub. Date: Nov. 20, 2025

(54) LEAK DETECTION SYSTEM AND METHOD, AND ELECTRONIC DEVICE HAVING SYSTEM

(71) Applicant: Wistron Corporation, New Taipei City (TW)

(72) Inventors: Tung-Yang TANG, New Taipei City (TW); Chu-Chia TSAI, New Taipei City (TW); Wen-Hua LIU, New Taipei City (TW)

(21) Appl. No.: 18/795,838

(22) Filed: Aug. 6, 2024

(30) Foreign Application Priority Data
May 15, 2024 (TW) 113118010

(51) Int. Cl. G01M 3/20

(52) U.S. Cl. CPC G01M 3/20

(57) ABSTRACT

A leak detection technology is provided. In some embodiments, an optical signal is generated in response to a chemical reaction between a first chemical substance located on the outside of a conduit or dissolved in a liquid with the conduit and a second chemical substance located on the outside of the conduit. An optical receiver senses the optical signal and outputs an output signal to a processor. The processor outputs an alarm signal based on the received output signal.

### CROSS-REFERENCE TO RELATED APPLICATION

This non-provisional application claims priority under 35 U.S.C. § 119(a) to Patent Application No. 113118010 filed in Taiwan, R.O.C. on May 15, 2024, the entire contents of which are hereby incorporated by reference.

### BACKGROUND

### Technical Field

The present disclosure relates to a leak detection system and method, and an electronic device having the system.

### Related Art

With the advent of the era of artificial intelligence (AI) with high computing power, the demand for high performance computing (HPC) and high-frequency and high-speed transmission is increasing, so that power consumption of the server continuously increases and also drives upgrading of the heat dissipation technology. At present, the heat dissipation capacity of air cooling is gradually becoming insufficient, and therefore a direct liquid cooling technology comes into being. However, the liquid cooling technology still has the potential risk of leakage, and leakage may lead to a failure of an electronic component.

In the conventional technology, leak detection cables are commonly employed to monitor leaks in liquid cooling systems. The leak detection cable is generally deployed under an elevated floor of a data center or in a server. However, the leak detection cable has a large volume and high costs, and therefore can only be deployed in critical areas. Moreover, the deployment process of the leak detection cable is complicated and requires manual installation, resulting in significant setup expenses.

In addition, the leak detection cable typically consists of two conductive wires separated by an absorbent material. When the absorbent material comes into contact with the liquid, resistance of the cable changes, and such a change may be detected and used to trigger an alarm. However, a coolant used in the liquid cooling system is usually pure water or pure water with additives (such as ethylene glycol and propylene glycol). These coolants have a very low conductivity, and even significant leaks may not be detected by the leak detection cable. In other words, in general, leaks cannot be detected immediately in their early stages. Typically, leaks are only detected when they have reached a significant level, by which time damage to electronic components or circuits may have already occurred.

### SUMMARY

In view of the above, the present disclosure provides a leak detection system, including a first chemical substance, a second chemical substance, an optical receiver, and a processor. The optical receiver is configured to sense an optical signal and output an output signal based on the sensed optical signal. The processor is electrically coupled to the optical receiver, and the processor is configured to receive the output signal and output an alarm signal based on the received output signal. In response to a leak, the first chemical substance reacts with the second chemical substance to generate the optical signal, and the optical receiver outputs the output signal, and the processor outputs the alarm signal.

In some embodiments, the first chemical substance may be located on the outside of a conduit or dissolved in a liquid within the conduit, and the second chemical substance may be located on the outside of the conduit. In response to the liquid leaking from the conduit, the leak causes the first chemical substance to react with the second chemical substance to generate the optical signal.

In some embodiments, the leak detection system may further include a transparent carrier. The transparent carrier may be arranged on the outside of the conduit, and the first chemical substance and the second chemical substance may be arranged on the transparent carrier.

In some embodiments, the transparent carrier may include a first substrate and a second substrate. The first substrate may be located between the second substrate and the conduit, and the first substrate may include a plurality of through holes. The first chemical substance and the second chemical substance may be respectively located on the first substrate and the second substrate.

In some embodiments, the transparent carrier may include a transparent tape. The transparent tape may include an adhesive surface and an emission surface. The first chemical substance and the second chemical substance may be located on the adhesive surface, and the transparent tape is attached to an outer surface of the conduit with the adhesive surface. The optical signal is emitted through the emission surface.

In some embodiments, the transparent carrier may include a transparent sleeve. The transparent sleeve is fitted around the conduit. The first chemical substance and the second chemical substance may be located within the transparent sleeve.

In some embodiments, the first chemical substance may be calcium oxide, and the second chemical substance may be aequorin. In another embodiment, the first chemical substance may be potassium ferricyanide, and the second chemical substance may be a luminol solution.

In some embodiments, the optical receiver may further include a band pass filter. The band pass filter may have a transmittance of greater than 80% at a light wavelength of about 465 nm or 425 nm.

In view of the above, the present disclosure provides an electronic device, including a conduit and a leak detection system. The conduit is filled with a liquid. The leak detection system includes a first chemical substance, a second chemical substance, an optical receiver, and a processor. The optical receiver is configured to sense an optical signal and output an output signal based on the sensed optical signal. The processor is electrically coupled to the optical receiver. The processor is configured to receive the output signal and output an alarm signal based on the received output signal. In response to the liquid leaking from the conduit, the liquid causes the first chemical substance to react with the second chemical substance to generate the optical signal. The optical receiver outputs the output signal, and the processor outputs the alarm signal.

In some embodiments, the first chemical substance may be located on the outside of a conduit or dissolved in a liquid inside the conduit, and the second chemical substance may be located on the outside of the conduit. In response to the liquid leaking from the conduit, the liquid causes the first chemical substance to react with the second chemical substance to generate the optical signal.

In some embodiments, the electronic device may further include a mainboard and a liquid cold plate. The optical receiver and the processor may be arranged on the mainboard. The liquid cold plate may be in communication with the conduit and is configured for heat exchange with an electronic component on the mainboard.

In some embodiments, the processor may be an embedded controller (EC), a super I/O chip, or a baseboard manager controller (BMC).

In view of the above, the present disclosure provides a leak detection method for detecting leakage of a liquid in a conduit. The method includes the following step: providing a first chemical substance and a second chemical substance. In response to the liquid leaking from the conduit, the liquid causing the first chemical substance to react with the second chemical substance to generate an optical signal. An optical receiver senses the optical signal and then outputs an output signal to a processor, and the processor receives the output signal and then outputs an alarm signal.

In some embodiments, the first chemical substance may be located on the outside of a conduit or dissolved in a liquid with the conduit, and the second chemical substance may be located on the outside of the conduit.

### BRIEF DESCRIPTION OF THE DRAWINGS

FIG. 1 is a schematic diagram of a leak detection system according to some embodiments of the present disclosure.

FIG. 2 is a schematic diagram showing configuration of a first chemical substance and a second chemical substance according to some embodiments of the present disclosure.

FIG. 3 is a schematic diagram showing configuration of a first chemical substance and a second chemical substance according to some embodiments of the present disclosure.

FIG. 4 is a schematic diagram showing configuration of a first chemical substance and a second chemical substance according to some embodiments of the present disclosure.

FIG. 5 is a schematic diagram of an electronic device having a leak detection system according to some embodiments of the present disclosure.

### DETAILED DESCRIPTION

Various embodiments are described in detail below. However, the embodiments are merely used as examples for description and do not limit or reduce the protection scope of the present disclosure. In addition, some elements are omitted in the drawings in the embodiments to clearly show the technical features of the present disclosure. Furthermore, the same reference numeral is used for indicating the same or similar elements in all of the drawings. The drawings of the present disclosure are only illustrative, which are not necessarily drawn to scale, and all details are not necessarily presented in the drawings.

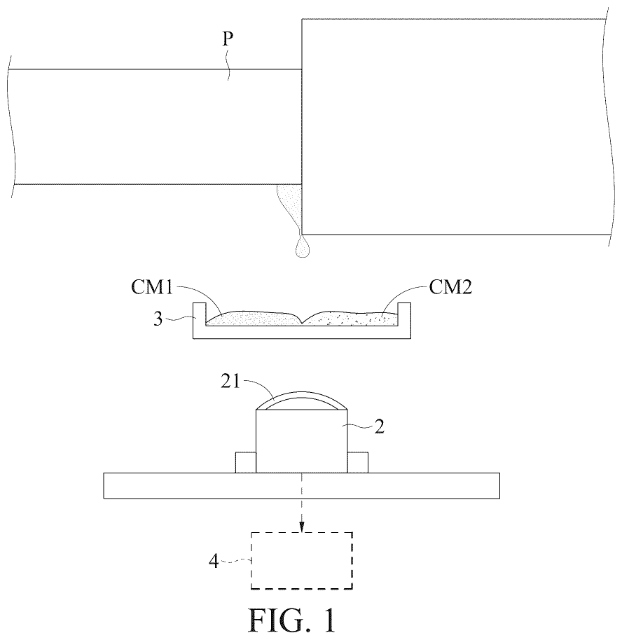

Refer to FIG. 1. FIG. 1 is a schematic diagram of a leak detection system according to some embodiments of the present disclosure. As shown in the figure, in some embodiments, the leak detection system may include a first chemical substance CM1, a second chemical substance CM2, an optical receiver 2, and a processor 4. The first chemical substance CM1 may be located on the outside of a conduit P or dissolved in a liquid within conduit P. The second chemical substance CM2 may be located on the outside of the conduit P.

Moreover, in some embodiments, the optical receiver 2 is configured to sense an optical signal and output an output signal based on the sensed optical signal. The processor 4 is electrically coupled to the optical receiver 2. The processor 4 is configured to receive the output signal and output an alarm signal based on the received output signal. In response to liquid leakage from the conduit P, the liquid causes the first chemical substance CM1 and the second chemical substance CM2 to undergo a chemical reaction to generate an optical signal. The optical receiver 2 outputs the output signal, and the processor outputs the alarm signal. In some embodiments, the aforementioned chemical reaction refers to a chemiluminescence reaction.

As shown in FIG. 1, in some embodiments, a transparent carrier 3 may be used to hold the first chemical substance CM1 and the second chemical substance CM2. The transparent carrier 3 may be a transparent container, which may be arranged on the outside of the conduit P, particularly in areas prone to leaks, such as the joints (e.g., welded, glued, or sleeved) of conduit P, the connection points between conduit P and fittings (not shown in the figure), and other high-risk leak zones (e.g., bends in conduit P that are susceptible to cracking).

In addition, in some embodiments, the first chemical substance CM1 and the second chemical substance CM2 may be housed on the translucent carrier (3) in a separated manner. In another embodiment, the first chemical substance and the second chemical substance may be mixed prior to being placed on the transparent carrier 3. In another embodiment, the first chemical substance CM1 may be dissolved or mixed into the liquid first, while only the second chemical substance CM2 is housed on the transparent carrier 3.

In some embodiments, the liquid within the conduit P is water, the first chemical substance CM1 may be calcium oxide powder, and the second chemical substance CM2 may be aequorin powder. When leaking water drops drip from the conduit P, the calcium oxide powder reacts with water to form calcium hydroxide (Ca(OH)₂), which exists in an aqueous solution in the form of calcium ions. The aforementioned chemical reaction is shown in the following equation:

CaO+H₂O→Ca(OH)₂→Ca²⁺+2OH—(aqueous solution)

Subsequently, the leaking water drops flow onto the aequorin powder, so that the aequorin powder dissolves in the leak. In this case, aequorin reacts with calcium ions (Ca²⁺) and emits bright blue fluorescence as an optical signal.

Furthermore, in some embodiments, the optical receiver 2 may be configured to have a strong response to a specific blue fluorescence center wavelength (about 465 nm). As a practical example, the optical receiver 2 may use a photo diode. In another embodiment, the optical receiver 2 may also be a chemiluminescence analytical instrument, for example, a fluorescence spectroscope, a chemiluminescence spectroscope, an electrochemiluminescence spectroscope, a photochemiluminescence spectroscope, or a photoelectrochemiluminescence spectroscope to further analyze optical properties of the optical signal, for example, a cold light intensity, a fluorescence intensity, a color, a cold light wavelength change, a fluorescence wavelength change, and a light wavelength change, so as to improve detection accuracy.

In addition, since ambient light sources may interfere with normal operation of the optical receiver 2, potentially leading to false alarms. A water-cooled server is used as an example for description below. Since there may be other LED light sources inside the server or on the motherboard, if the emission spectrum of these LED light sources overlaps with the emission spectrum of the optical signal, it may cause the optical receiver 2 to misjudge.

Accordingly, in some embodiments, the optical receiver 2 may further include a band pass filter 21. The band pass filter 21 has a transmittance of greater than 80%, preferably greater than 95%, at a light wavelength of about 465 nm, so as to filter out interference from other LED light sources and perform detection only for the specific light-emitting wavelength (465 nm). In another embodiment, the band pass filter 21 can be configured to match the transmittable light wavelength band according to the different optical signal wavelengths generated by other chemiluminescence reactions.

Furthermore, in some embodiments, each milligram of aequorin reacts with calcium ions to emit approximately 1.6 lumens of blue light, which is equivalent to 0.127 candelas. Luminance of 50 mg of aequorin is comparable to a typical small nightlight used in homes at night, making it bright enough to see the surroundings in the dark. Generally, a size of the water drop leaking from the conduit P is about 0.05 ml to 2 ml. Therefore, a single drop of leak can dissolve at least 0.02 mg of aequorin, and its luminescence can be detected by a general photo diode.

In some embodiments, the first chemical substance CM1 and the second chemical substance CM2 may exist in a solvent and are respectively in the form of solutions. In this case, the first chemical substance CM1 may be potassium ferricyanide, which may be dissolved in a liquid (water), and the second chemical substance CM2 may be a luminol solution. In some embodiments, the luminol solution may be made from a mixture of a luminol solution and a 3% hydrogen peroxide solution, and the luminol solution may be made from a mixture of 0.2 g luminol, 1.5 g potassium hydroxide, and 25 ml water. In this embodiment, the band pass filter 21 has a transmittance of greater than 80%, preferably greater than 95%, at the light wavelength of about 425 nm.

In another embodiment, the luminol solution can also be supplemented with a gel-forming agent, which is in the form of a gel, making it easier to store and preventing leakage of the luminol solution. The gel-based agent may be composed of aqua, propylene glycol, carbomer, triethanolamine, DMDM hydantoin, and phenoxyethanol.

In another embodiment, the first chemical substance CM1 can be omitted when the conduit P is made of iron or contains iron elements. This is because when an iron conduit is oxidized to form rust and rust water, the rust water contains iron ions. When a leak occurs in the conduit P, the rust water can react with the luminol solution to emit blue fluorescence as an optical signal. In addition, in another embodiment, the iron conduit is not necessarily oxidized because the iron conduit naturally precipitates iron ions and dissolve the iron ions in the liquid. However, after a period of use, when a certain level of dissolved iron ions is reached and a leak occurs, the iron ions in the liquid also react with the luminol solution to emit an optical signal.

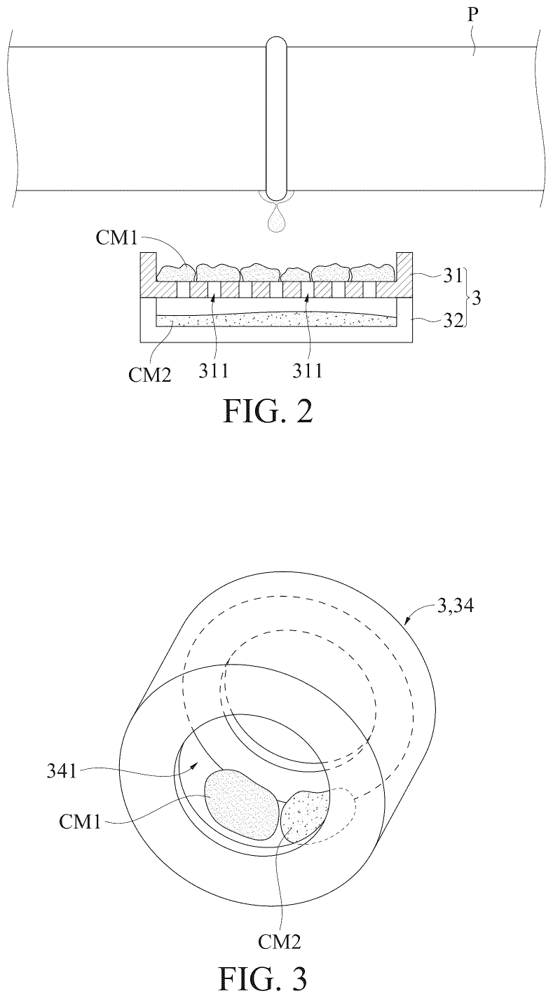

Refer to FIG. 2. FIG. 2 is a schematic diagram showing configuration of a first chemical substance CM1 and a second chemical substance CM2 according to some embodiments of the present disclosure. As shown in the figure, in some embodiments, a transparent carrier 3 may include a first substrate 31 and a second substrate 32. The first substrate 31 and the second substrate 32 may be stacked, and the first substrate 31 may be located between the second substrate 32 and the conduit P. The first substrate 31 includes a plurality of through holes 311. The first chemical substance CM1 and the second chemical substance CM2 may be respectively located on the first substrate 31 and the second substrate 32.

Accordingly, when leakage occurs in the conduit P, the liquid first falls into the first substrate 31 and dissolves the first chemical substance CM1. Then, the liquid flows to the second substrate 32 through the through holes 311 in the first substrate 31, and reacts with the second chemical substance CM2 to emit an optical signal. In some embodiments, the first chemical substance CM1 can be slightly block-shaped calcium oxide, so as to prevent the calcium oxide powder from directly falling onto the second substrate 32 through the through holes 311. In addition, in the embodiment shown in FIG. 2, the second substrate 32 needs to be made of a transparent material, and the first substrate 31 is preferably made of the transparent material, so as to facilitate observation for a user and early detection of leaks.

Refer to FIG. 3. FIG. 3 is a schematic diagram showing configuration of a first chemical substance CM1 and a second chemical substance CM2 according to some embodiments of the present disclosure. In the embodiment shown in FIG. 3, a transparent carrier 3 may include a transparent sleeve 34 having a through hole 341. The conduit (not shown in FIG. 3) may pass through the through hole 341. Therefore, the transparent sleeve 34 may be directly sleeved on the conduit (not shown in FIG. 3). Moreover, an annular space is provided inside the transparent sleeve 34, and the first chemical substance CM1 and the second chemical substance CM2 may be located in the annular space.

In some embodiments, the transparent sleeve 34 may be configured with a seal ring or an O-shaped ring, for example, in the through hole 341. Accordingly, when leakage occurs in the conduit (not shown in FIG. 3), a liquid flows into the annular space. In addition to triggering the chemiluminescence reaction, the transparent sleeve 34 can also seal the liquid for at least a period of time, to prevent the liquid from flowing out of the transparent sleeve 34.

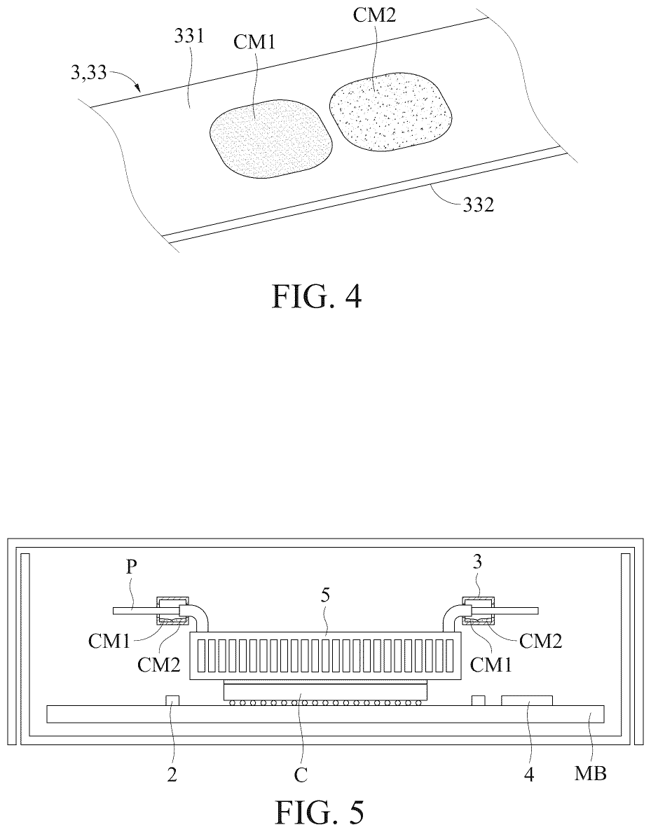

Refer to FIG. 4. FIG. 4 is a schematic diagram showing configuration of a first chemical substance CM1 and a second chemical substance CM2 according to some embodiments of the present disclosure. In the embodiment shown in FIG. 4, the transparent carrier 3 is a transparent tape 33, and the transparent tape 33 includes an adhesive surface 331 and an emission surface 332. The first chemical substance CM1 and the second chemical substance CM2 are located on the adhesive surface 331.

Accordingly, the transparent tape 33 may be attached to an outer surface of the conduit (not shown in FIG. 4) with the adhesive surface 331. When leakage occurs, the liquid triggers a chemiluminescence reaction between the first chemical substance CM1 and the second chemical substance CM2 on the transparent tape 33. In this case, the optical signal generated by the chemical reaction may be emitted through the emission surface 332. The advantages of this embodiment include low cost and easy installation.

Refer to FIG. 5. FIG. 5 is a schematic diagram of an electronic device having a leak detection system according to some embodiments of the present disclosure. In the following embodiments, an example in which the electronic device is a server is used, but the present disclosure should not be limited thereto. Any electronic devices that may dissipate heat through liquid cooling may be applied to the leak detection system in the present disclosure.

FIG. 5 shows a mainboard MB, an electronic component C, and a liquid cold plate 5. In some embodiments, the mainboard MB is a server mainboard. The electronic component C may be a cooled component, such as a CPU or a GPU. The liquid cold plate 5 is a hollow block component with internal flow paths or fluid chambers. In addition, the liquid cold plate 5 may be connected to a heat exchanger (not shown in the figure) or a cooling distribution unit (CDU) through a conduit P. In other words, the cooling distribution unit (not shown in the figure) may deliver the liquid to the liquid cold plate 5 through the conduit P, and after the liquid cold plate 5 may performs heat exchange with the electronic component C, the liquid is pushed and returned to the cooling liquid distribution unit, thus forming a fluid circulation.

As shown in the figure as well, a transparent carrier 3 is arranged on the outside of the conduit P. For example, the transparent sleeve 34 as described in the previous embodiments may be used as the transparent carrier 3, and a first chemical substance CM1 and a second chemical substance CM2 are accommodated within the transparent carrier 3. In addition, the mainboard MB is provided with an optical receiver 2 and a processor 4. The optical receiver 2 may be a photo diode, and is arranged around the transparent carrier 3 to receive an optical signal. In some embodiments, the processor 4 may be a controller built in the mainboard MB, such as an embedded controller (EC), a super I/O chip, or a baseboard manager controller (BMC).

When a small amount of liquid (coolant) leaks from the conduit P of the liquid cold plate 5 and drips onto the transparent carrier 3, the first chemical substance CM1 and the second chemical substance CM2 may be triggered to dissolve, mix, and undergo a chemiluminescence reaction, thereby emitting a specific wavelength of an optical signal (fluorescence). Furthermore, by controlling the chip (such as the processor 4) and software settings, when a fluorescence intensity of the optical signal received by the optical receiver 2 is higher than a set value, that is, it is determined that a leak occurs, and the processor 4 takes an appropriate action, for example, outputs an alarm signal, stops system operation, and recycles the liquid (cooling liquid).

In larger deployment scenarios, where multiple servers form a rack and multiple racks constitute a data center, the aforementioned leak detection system can be deployed in each server. Since the servers in the data center are housed within racks, the interior of each server chassis is dark during normal operation, free from interference from external ambient light. Therefore, the sensitivity and accuracy of leak detection can be significantly enhanced. Moreover, each server may be connected to a central control room of the data center via signal, which facilitates centralized management of all leak detection systems from the central control room.

Specifically, in some embodiments, due to use of a chemiluminescent material for leak detection, the amount of materials used is small. Moreover, both the chemiluminescent material and the optical receiver are elements that are readily available components in the market, making them cost-effective. In addition, by simply adding a light receiver to the motherboard of each server, leak detection can be performed directly, and even small leaks can be detected, thus preventing damage caused by large leaks. Furthermore, since all the detection and processing components are located on the mainboard, the optical receiver may be electrically connected to the processor on the mainboard, which facilitates programmed control and management and facilitates deployment without additional cables, thereby saving costs.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A leak detection system, comprising:
a first chemical substance;
a second chemical substance;
an optical receiver, configured to sense an optical signal and output an output signal based on the optical signal; and
a processor, electrically coupled to the optical receiver, wherein the processor is configured to receive the output signal and output an alarm signal based on the received output signal, wherein
in response to a leak, the first chemical substance reacts with the second chemical substance to generate the optical signal; the optical receiver outputs the output signal, and the processor outputs the alarm signal.

2. The leak detection system according to claim 1, wherein the first chemical substance is located on the outside of a conduit or dissolved in a liquid within the conduit, the second chemical substance is located on the outside of the conduit; and wherein, in response to the liquid leaking from the conduit, the leak causes the first chemical substance to react with the second chemical substance to generate the optical signal.

3. The leak detection system according to claim 2, further comprising a transparent carrier, wherein the transparent carrier is arranged on the outside of the conduit, and the first chemical substance and the second chemical substance are arranged on the transparent carrier.

4. The leak detection system according to claim 3, wherein the transparent carrier comprises a first substrate and a second substrate, the first substrate is located between the second substrate and the conduit, the first substrate comprises a plurality of through holes, and the first chemical substance and the second chemical substance are respectively located on the first substrate and the second substrate.

5. The leak detection system according to claim 3, wherein the transparent carrier comprises a transparent tape, the transparent tape comprises an adhesive surface and an emission surface, the first chemical substance and the second chemical substance are located on the adhesive surface, the transparent tape is attached to an outer surface of the conduit with the adhesive surface, and the optical signal is emitted through the emission surface.

6. The leak detection system according to claim 3, wherein the transparent carrier comprises a transparent sleeve, the transparent sleeve is fitted around the conduit, and the first chemical substance and the second chemical substance are located within the transparent sleeve.

7. The leak detection system according to claim 1, wherein the first chemical substance is calcium oxide, and the second chemical substance is aequorin.

8. The leak detection system according to claim 7, wherein the optical receiver further comprises a band pass filter, and the band pass filter has a transmittance of greater than 80% at a light wavelength of about 465 nm.

9. The leak detection system according to claim 1, wherein the first chemical substance is potassium ferricyanide, and the second chemical substance is a luminol solution.

10. The leak detection system according to claim 9, wherein the optical receiver further comprises a band pass filter, and the band pass filter has a transmittance of greater than 80% at a light wavelength of about 425 nm.

11. An electronic device, comprising:
a conduit, filled with a liquid; and
a leak detection system, comprising:
a first chemical substance;
a second chemical substance;
an optical receiver, configured to sense an optical signal and output an output signal based on the optical signal; and
a processor, electrically coupled to the optical receiver, wherein the processor is configured to receive the output signal and output an alarm signal based on the received output signal, wherein
in response to the liquid leaking from the conduit, the liquid causes the first chemical substance to react with the second chemical substance to generate the optical signal, the optical receiver outputs the output signal, and the processor outputs the alarm signal.

12. The electronic device according to claim 11, wherein the first chemical substance is located on the outside of a conduit or dissolved in a liquid with the conduit, the second chemical substance is located on the outside of the conduit; and in response to the liquid leaking from the conduit, the liquid causes the first chemical substance to react with the second chemical substance to generate the optical signal.

13. The electronic device according to claim 11, further comprising a mainboard and a liquid cold plate, wherein the optical receiver and the processor are arranged on the mainboard, and the liquid cold plate is in communication with the conduit and configured for heat exchange with an electronic component on the mainboard.

14. The electronic device according to claim 13, wherein the processor is an embedded controller (EC), a super I/O chip, or a baseboard manager controller (BMC).

15. The electronic device according to claim 11, wherein the leak detection system further comprises a transparent carrier, the transparent carrier is arranged on the outside of the conduit, and the first chemical substance and the second chemical substance are arranged on the transparent carrier.

16. The electronic device according to claim 15, wherein the transparent carrier comprises a first substrate and a second substrate, the first substrate is located between the second substrate and the conduit, the first substrate comprises a plurality of through holes, and the first chemical substance and the second chemical substance are respectively located on the first substrate and the second substrate.

17. The electronic device according to claim 15, wherein the transparent carrier comprises a transparent tape, the transparent tape comprises an adhesive surface and an emission surface, the first chemical substance and the second chemical substance are located on the adhesive surface, the transparent tape is attached to an outer surface of the conduit with the adhesive surface, and the optical signal is emitted through the emission surface.

18. The electronic device according to claim 15, wherein the transparent carrier comprises a transparent sleeve, the transparent sleeve is fitted around the conduit, and the first chemical substance and the second chemical substance are located within the transparent sleeve.

19. The electronic device according to claim 11, wherein the first chemical substance of the leak detection system is calcium oxide, and the second chemical substance is aequorin.

20. The electronic device according to claim 11, wherein the optical receiver of the leak detection system further comprises a band pass filter.

21. A leak detection method, for detecting leakage of a liquid within a conduit, the method comprising the following step:
providing a first chemical substance and a second chemical substance; wherein
in response to the liquid leaking from the conduit, the liquid causing the first chemical substance to react with the second chemical substance to generate an optical signal; and
an optical receiver senses the optical signal and then outputs an output signal to a processor, and the processor receives the output signal and then outputs an alarm signal.

22. The leak detection method according to claim 21, wherein the first chemical substance is located on the outside of the conduit or dissolved in a liquid within the conduit, the second chemical substance is located on the outside of the conduit.
